(19) United States
(12) Patent Application Publication
(10) Pub. No.: US 2026/0319513 A1
(43) Pub. Date: Oct. 15, 2026

(54) PATH PLANNING DEVICE, METHOD, PROGRAM, AND MOVEMENT CONTROL SYSTEM

(71) Applicant: OMRON CORPORATION, Kyoto (JP)

(72) Inventors: Kohei HONDA, Tokyo (JP); Ryo YONETANI, Tokyo (JP); Mai KUROSE NISHIMURA, Tokyo (JP)

(73) Assignee: OMRON CORPORATION, Kyoto (JP)

(21) Appl. No.: 19/168,616

(22) PCT Filed: Mar. 22, 2024
(86) PCT No.: PCT/JP2024/011492

§ 371 Date: Sep. 24, 2025

(30) Foreign Application Priority Data
Apr. 21, 2023 (JP) 2023-070470

(51) Int. Cl. G05D 1/644; G05B 13/02; G05D 1/246; G05D 101/15

(52) U.S. Cl. CPC G05D 1/644; G05B 13/0265; G05D 1/2462; G05D 2101/15

(57) ABSTRACT

A path planning device includes a memory and a processor coupled to the memory. The processor is configured to compute a low-cost path from a starting point to a goal point based on a pre-constructed map including positions of obstacles; specify, for each time, a velocity or angular velocity of a moving body to follow the low-cost path; acquire sensor information measured for obstacles in a periphery of the moving body at each time; re-compute the low-cost path based on the map and the sensor information; store a time series of the sensor information and trajectory of the moving body; and determine whether re-computing is to be performed using a pre-trained determination model for determining whether it is a timing for re-computing to be performed based on the time series of the sensor information, the trajectory of the moving body, the low-cost path, and the goal point.

### TECHNICAL FIELD

The present disclosure relates to a path planning device, a path planning method, a path planning program, and a movement control system.

### BACKGROUND ART

Hitherto, in a ROS Navigation Stack generally employed to implement autonomous movement, a state called “robot not able to proceed” is defined heuristically from information of distance from obstacles and robot stop time, and path re-planning is implemented based on this. Alternatively, path re-planning is performed at an appropriate cycle of 1 Hz or the like.

Moreover, there is a method to train a machine learning model for computing waypoints from observed obstacle information called “where to head next on global planned (global plan) path” (see, for example, “Connecting Deep-Reinforcement-Learning-based Obstacle Avoidance with Conventional Global Planners using Waypoint Generators” by Kasttner et al. at https://arxiv.org/pdf/2104.03663.pdf)).

### SUMMARY OF INVENTION

### Technical Problem

However, in the above ROS Navigation Stack, the heuristic rules therein are not able to guarantee optimization of goal arrival probability or time taken.

Moreover, in the method described in “Connecting Deep-Reinforcement-Learning-based Obstacle Avoidance with Conventional Global Planners using Waypoint Generators” by Kasttner et al. at https://arxiv.org/pdf/2104.03663.pdf), due to continuing to utilize a path that has been computed from a known obstacle map as the path itself, this is not compatible with discovering a diversion path by path re-planning for a case in which “a new obstacle emerges and path has become blocked partway along”.

In consideration of the above circumstances, an object of the present disclosure is to re-compute a low-cost path to a goal point at an appropriate timing.

### Solution to Problem

In order to achieve the above object, a path planning device according to the present disclosure is configured including a global planning unit that computes a low-cost path from a starting point to a goal point based on a pre-constructed map including positions of obstacles, a local planning unit that specifies, for each time, a velocity or angular velocity of a moving body in order to follow the low-cost path, a sensing unit that acquires sensor information measured for obstacles in a periphery of the moving body at each time, a re-planning unit that re-computes the low-cost path based on the map and the sensor information, a storage unit that stores a time series of the sensor information and a trajectory of the moving body, and a timing determination unit that determines whether or not computing by the re-planning unit is to be performed using a pre-trained determination model for determining whether or not it is a timing for computation to be performed by the re-planning unit based on the time series of sensor information, the trajectory of the moving body, the low-cost path, and the goal point. The low-cost path referred to here may include, from out of calculable paths, a path having a shortest movement distance, a path having a shortest movement time, a path having a minimum movement energy, and a path having a low risk of becoming unable to move.

Moreover, a path planning method according to the present disclosure is of processing for execution by a computer. The processing includes computing a low-cost path from a starting point to a goal point based on a pre-constructed map including positions of obstacles, specifying for each time a velocity or angular velocity of a moving body in order to follow the low-cost path, acquiring sensor information measured for obstacles in a periphery of the moving body at each time, storing a time series of the sensor information and a trajectory of the moving body in a storage unit, determining, based on the time series of sensor information, the trajectory of the moving body, the low-cost path, and the goal point, whether or not to re-compute the low-cost path by using a pre-trained determination model for determining whether or not it is a timing for re-computing the low-cost path, and re-computing the low-cost path based on the map and the sensor information in cases in which determination was to re-compute the low-cost path.

Moreover, a path planning program according to the present disclosure causes a computer to function as a global planning unit that computes a low-cost path from a starting point to a goal point based on a pre-constructed map including positions of obstacles, a local planning unit that specifies, for each time, a velocity or angular velocity of a moving body in order to follow the low-cost path, a sensing unit that acquires sensor information measured for obstacles in a periphery of the moving body at each time, a re-planning unit that re-computes the low-cost path based on the map and the sensor information, a storage unit that stores a time series of the sensor information and a trajectory of the moving body, and a timing determination unit that determines whether or not computing by the re-planning unit is to be performed using a pre-trained determination model for determining whether or not it is a timing for computation to be performed by the re-planning unit based on the time series of sensor information, the trajectory of the moving body, the low-cost path, and the goal point.

Moreover, a movement control system according to the present disclosure includes a control device and a moving body. The control device includes a global planning unit that computes a low-cost path from a starting point to a goal point based on a pre-constructed map including positions of obstacles, a local planning unit that specifies, for each time, a velocity or angular velocity of the moving body in order to follow the low-cost path, a sensing unit that acquires sensor information measured for obstacles in a periphery of the moving body at each time, a re-planning unit that re-computes the low-cost path based on the map and the sensor information, a storage unit that stores a time series of the sensor information and a trajectory of the moving body, a timing determination unit that determines whether or not computing by the re-planning unit is to be performed using a pre-trained determination model for determining whether or not it is a timing for computation to be performed by the re-planning unit based on the time series of sensor information, the trajectory of the moving body, the low-cost path, and the goal point, and a communication unit that notifies the moving body of the velocity or angular velocity of the moving body specified for each time. The moving body notifies the control device of sensor information measured for obstacles in the periphery of the moving body at each time, and moves according to the notified velocity or angular velocity of the moving body.

### Advantageous Effects

A path planning device, method, program and movement control system according to the present disclosure enable re-computing of a low-cost path to a goal point to be performed at an appropriate timing.

### BRIEF DESCRIPTION OF DRAWINGS

FIG. 1 is a block diagram illustrating a schematic configuration of a movement control system.

FIG. 2 is a block diagram illustrating a hardware configuration of a control device.

FIG. 3A is a diagram illustrating an example of a map.

FIG. 3B is a diagram illustrating an example of a map to which obstacles found from sensor information have been added.

FIG. 4 is a flowchart illustrating a flow of path planning processing.

### DESCRIPTION OF EMBODIMENTS

Description follows regarding an example of an exemplary embodiment of the present disclosure, with reference to the drawings. Note that the same reference numerals will be appended across the drawings to the same or equivalent configuration elements and parts. Moreover, dimensions and proportions in the drawings are exaggerated for ease of explanation, and sometimes differ from actual proportions.

### Exemplary Embodiment of Present Disclosure-Outline

In an exemplary embodiment of the present disclosure, determination is made as to whether or not it is a timing to re-compute a low-cost path based on a time series of sensor information and on a trajectory of an agent.

The technology of the present disclosure is compatible to moving bodies as a whole that need to move autonomously from a given location to a different location safely without colliding with obstacles, such as self-driving vehicles and autonomous mobile robots, autonomous arial drones, and the like. On one hand, there is an assumption that global planning is utilized to compute a low-cost path in movement over long distances and movement in an environment in which there are many obstacles. However, in an environment where there are unknown/mobile obstacles such as pedestrians and seats/doors and the like, there is a need for path re-planning in order to avoid such obstacles. A determination rule for which timing such path re-planning is performed needs a planner to craft, including setting detailed parameters according to the environment and global planning used and the type of local planning, and takes a lot of time.

The technology of the present disclosure accordingly trains a determination model for determining a timing of path re-planning using reinforcement learning. Because an agent becomes able to acquire a determination model autonomously by themselves, there is no need for manpower cost taken to craft such a determination rule.

### Movement Control System Configuration

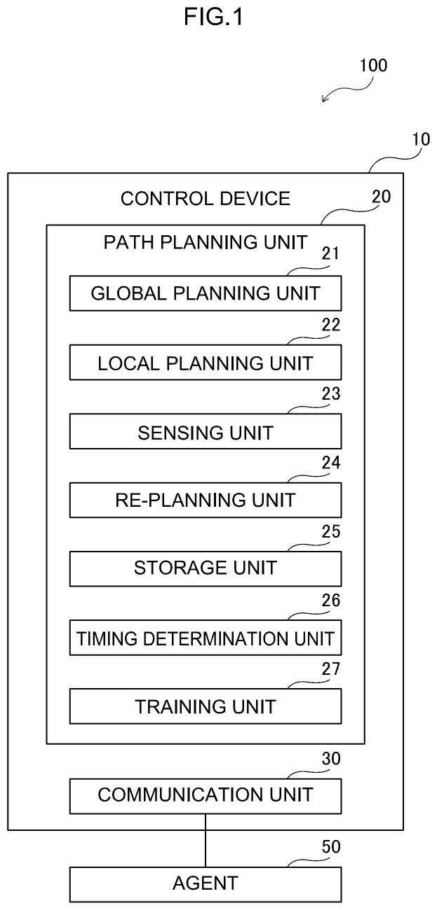

As illustrated in FIG. 1, a movement control system 100 according to the present exemplary embodiment includes a control device 10 and an agent 50.

The agent 50 is, for example, a self-driving vehicle in autonomous intersection management, an autonomous mobile robot (AMR) or an automatic guided vehicle (AGV) in a warehouse or factory, a drone in an unmanned delivery system, or the like. The agent 50 includes a movement mechanism to perform travel, flight, or the like, a communication mechanism to perform communication with the control device 10, and a movement control mechanism to control the movement mechanism so as to move according to a planned path. Note that the agent is an example of a moving body.

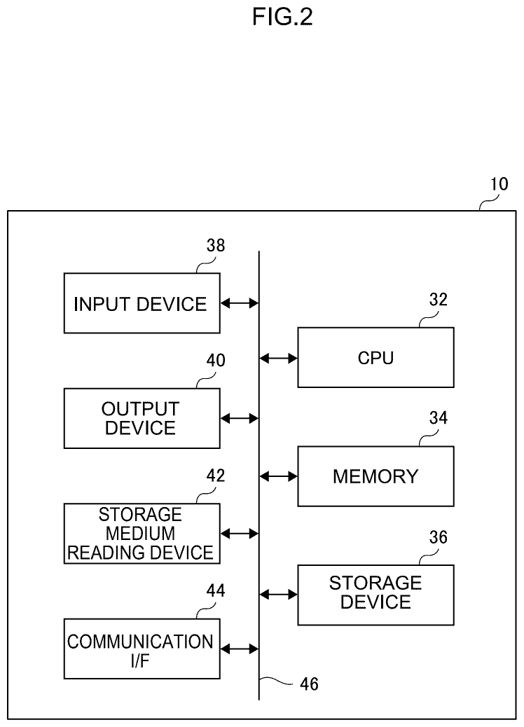

FIG. 2 is a block diagram illustrating a hardware configuration of the control device 10. As illustrated in FIG. 2, the control device 10 is a computer including a central processing unit (CPU) 32, memory 34, a storage device 36, an input device 38, an output device 40, a storage medium reading device 42, and a communication interface (I/F) 44. Each configuration is connected together through a bus 46 so as to be capable of communicating with each other.

A path planning program for executing path planning processing is stored on the storage device 36. The CPU 32 is a central processing unit that executes various programs and controls each configuration. Namely, the CPU 32 reads a program from the storage device 36 and executes the program using the memory 34 as a work area. The CPU 32 controls the above configuration sections and performs various computation processing according to the program stored on the storage device 36.

The memory 34 is configured by random access memory (RAM), and is employed as a work area to temporarily store programs and data. The storage device 36 is configured by read only memory (ROM), and a hard disk drive (HDD), a solid state drive (SSD), or the like, and various programs including an operating system and various data are stored thereon.

The input device 38 is a device for performing various inputs and is, for example, a keyboard, a mouse, or the like. The output device 40 is a device for outputting various information and is, for example, a display, a printer, or the like. The output device 40 may also function as the input device 38 by utilizing a touch panel display therefor.

The storage medium reading device 42 performs reading of data stored on various storage mediums, such as compact disk (CD)-ROM, digital versatile disc (DVD)-ROM, Blu-ray disc, universal serial bus (USB) memory, or the like, and performs writing of data to these storage mediums. The communication I/F 44 is an interface for communication with other devices, and employs a standard such as, for example, Ethernet (registered trademark), FDDI, Wi-Fi (registered trademark).

The control device 10 includes, as illustrated in FIG. 1, from a functional perspective, a path planning unit 20 and a communication unit 30. The path planning unit 20 moreover includes a global planning unit 21, a local planning unit 22, a sensing unit 23, a re-planning unit 24, a storage unit 25, a timing determination unit 26, and a training unit 27. Note that the path planning unit 20 is an example of a path planning device of the present disclosure. Each of the functional configurations is implemented by the CPU 32 reading a path planning program stored on the storage device 36, and expanding and executing the control program in the memory 34.

Based on a pre-constructed map including positions of obstacles, the global planning unit 21 computes a path not colliding with obstacles that is also a low-cost path from a starting point to a goal point.

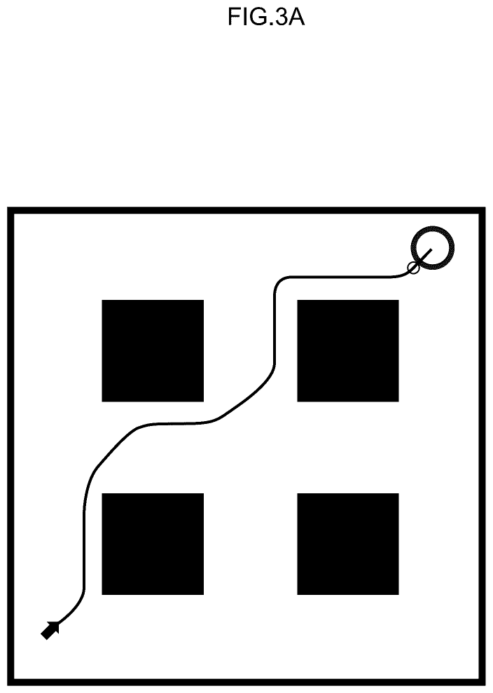

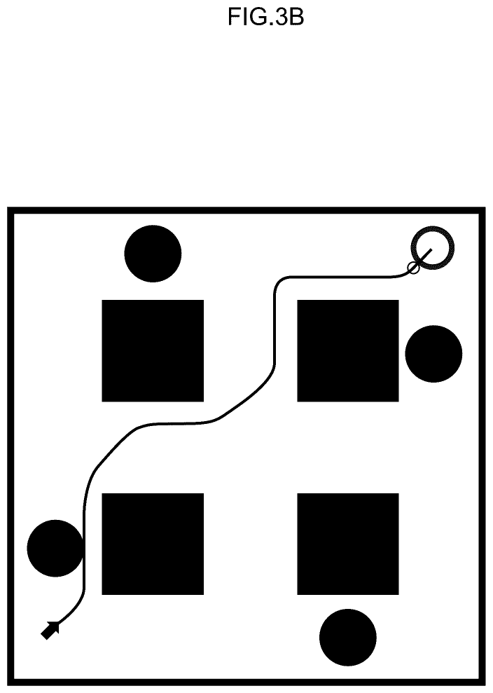

In the present exemplary embodiment, as illustrated in FIG. 3A, positions of static obstacles (solid black squares) are determined on a map, and then based on this map, a low-cost path from a starting point to a goal point is planned. In the example illustrated in FIG. 3A, the low-cost path from a starting point indicated by an arrow to a goal point indicated by a white centered circle mark is indicated by a solid line.

The local planning unit 22 specifies a velocity and angular velocity of the agent 50 at each time so as to follow the planned low-cost path.

The sensing unit 23 acquires sensor information measured for obstacles in the surroundings of the agent 50 at each time. Specifically, at each time, sensor information measured for obstacles at the periphery of the agent 50 by sensors provided to the agent 50 is transmitted from the agent 50 to the control device 10, and the sensing unit 23 acquires the sensor information received at each time.

In cases in which the timing determination unit 26 has determined that it is a timing for computation to be performed by the re-planning unit 24, the re-planning unit 24 re-computes a low-cost path to the goal point based on the map and on measurement results by the sensing unit 23.

In the present exemplary embodiment, as illustrated in FIG. 3B, a path not colliding with obstacles that is also a low-cost path from a starting point to a goal point is re-planned based on positions of static obstacles (solid black squares) pre-set on a map, and positions of mobile obstacles (solid black circles) found based on the measurement results from the sensing unit 23.

The storage unit 25 stores a time series of the sensor information and a trajectory of the agent 50. Specifically, the time series of the sensor information includes sensor information acquired by the sensing unit 23 for each time up to the current time. Moreover, the trajectory of the agent 50 indicates positions of the agent 50 at each time until the current time.

The timing determination unit 26 determines whether or not it is a timing for computation to be performed by the re-planning unit 24 using a pre-trained determination model for determining whether or not it is a timing for computation to be performed by the re-planning unit 24 based on the time series of sensor information, the trajectory of the agent 50, the low-cost path, and the goal point.

Specifically, a policy π, serving as a determination model, trained by the training unit 27 is employed to decide an action aₜ, indicating whether or not it is a timing for computation to be performed by the re-planning unit 24 for a state sₜ including a time series of sensor information up to the current time t, the trajectory of the agent 50 up to the current time t, the latest low-cost path, and the goal point.

The training unit 27 trains the policy, serving as the determination model, using reinforcement learning from movement history data from past starting points to goal points, which is movement history data including sensor information at each time, a trajectory of the agent 50, a low-cost path at each time, and a goal point.

A reward in the reinforcement learning is determined based on, in the movement history data, whether or not the goal point has been arrived at, or on an arrival time at the goal point.

Description follows regarding the reinforcement learning. Reinforcement learning is a method to train an optimum action through trial and error in an environment. In reinforcement learning a reward is used in place of training data. A cumulative reward Gt is defined as expressed by the following equation, wherein y is a reward discount rate and Rt is the reward at each time. Note that t represents time.

$${G}_{t} = {𝔼}_{( {s}_{t} , {a}_{t} ) \sim π} [ {\sum }_{t = 0}^{∞} {γ}^{t} {R}_{t} ] .$$

Note that E_{(st,at)~π} [·] expresses an expected value of action at being selected in state sₜ under policy π.

An example of a method for training the policy π is, for example, an algorithm Deep Q-Network (DQN) (see V. Mnih, K. Kavukcuoglu, D. Silver, A. A. Rusu, J. Veness, M. G. Bellemare, A. Graves, M. Riedmiller, A. K. Fidjeland, G. Ostrovski, et al., “Human-level control through deep reinforcement learning,” nature, vol. 518, no. 7540, pp. 529-533, 2015).

In the present exemplary embodiment, action at denotes, for a state sₜ that combines a time series of sensor information up to the current time t, a trajectory of the agent 50 up to the current time t, a latest low-cost path, and a goal point, whether or not it is a timing for computation to be performed by the re-planning unit 24 according to this state sₜ and the policy π.

The communication unit 30 notifies the agent 50 of the velocity and angular velocity for the agent 50 specified at each time.

Moreover, the communication unit 30 receives sensor information measured for obstacles at the periphery of the agent 50 at each time as notified from the agent 50.

### Operation and Advantageous Effects of Movement Control System

Next, description follows regarding the operation and advantageous effects of the movement control system 100 according to the present exemplary embodiment.

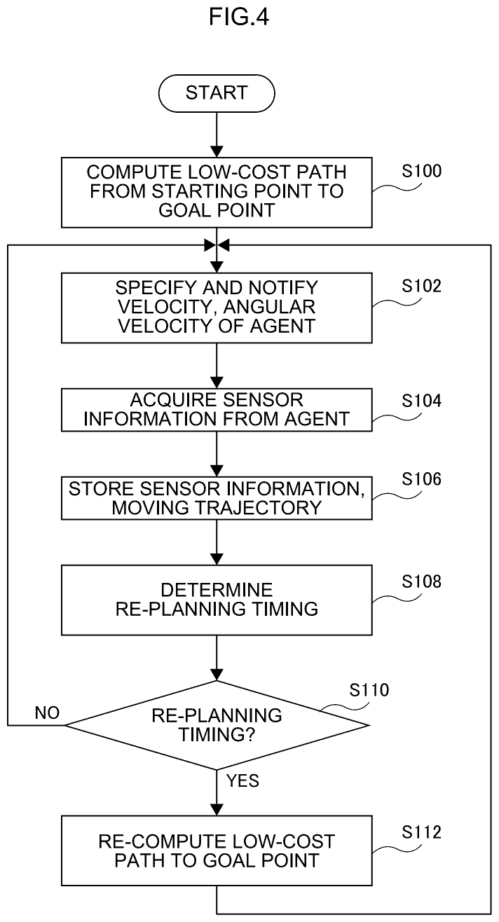

FIG. 4 is a flowchart illustrating a flow of path planning processing executed by the CPU 32 of the control device 10. The CPU 32 functions as each functional configuration of the control device 10 by the CPU 32 reading the path planning program from the storage device 36 and expanding and executing the path planning program in the memory 34, and the path planning processing illustrated in FIG. 4 is thereby executed. A map, starting point, and goal point are input to the control device 10, and sensor information at each time is notified from the agent 50. The policy a serving as the determination model is an initially set policy. Note that the path planning processing is an example of a path planning method.

At step S100, the global planning unit 21 computes a low-cost path from a starting point to a goal point based on a pre-constructed map including positions of obstacles.

Next, at step S102, the local planning unit 22 specifies a velocity and angular velocity at the current time for the agent 50 in order to follow the planned low-cost path. The communication unit 30 then notifies the velocity and angular velocity for the current time to the agent 50.

Next, at step S104, the sensing unit 23 acquires the sensor information measured for obstacles in the periphery of the agent 50 as received by the communication unit 30.

Next, at step S106, the time series of sensor information up to the current time t, and the trajectory of the agent 50, are stored in the storage unit 25.

Next, at step S108, based on the time series of the sensor information, the trajectory of the agent 50, the low-cost path, and the goal point, the timing determination unit 26 employs the policy π serving as the determination model to determine whether or not it is a timing for computation to be performed by the re-planning unit 24.

Next, at step S110, determination is made as to whether or not determination at step S108 was that it is a timing for computation to be performed by the re-planning unit 24. Processing transitions to step S112 in cases in which determination is that it is a timing for computation to be performed by the re-planning unit 24. However, processing returns to step S102 in cases in which determination is that it is not a timing for computation to be performed by the re-planning unit 24.

Next, at step S112, based on the map and the measurement results by the sensing unit 23, the re-planning unit 24 re-computes the low-cost path to the goal point, and then processing returns to step S102.

The path planning processing is ended when the agent 50 has arrived at the goal point. The training unit 27 trains the policy π serving as the determination model using reinforcement learning based on the movement history data to the goal point. The reward in the reinforcement learning is determined based on, in the movement history data, whether or not the goal point has been arrived at, or on an arrival time at the goal point.

The control device 10 executes the path planning processing when the agent 50 once again moves from a starting point to a goal point. When doing so, the trained policy π serving as the determination model is employed.

As described above, the movement control system according to the present exemplary embodiment employs the pre-trained determination model, which is for determining whether or not it is a timing to re-compute the low-cost path based on a time series of sensor information, a trajectory of the agent, a low-cost path, and a goal point, to determine whether or not to re-compute the low-cost path. This thereby enables the low-cost path to the goal point to be re-computed at an appropriate timing.

Moreover, the policy serving as the determination model is trained by reinforcement learning from the movement history data from past starting points to goal points, which is movement history data including sensor information at each time, the trajectory of the agent, the low-cost path at each time, and the goal point. This thereby enables an appropriate timing for re-planning the low-cost path to be learnt based on the movement history data autonomously acquired by the agent. In particular, a determination model to determine a timing to re-plan a low-cost path so as to maximize a probability of being able to arrive at a goal point in a limited time period without colliding with obstacles, or so as to achieve a minimum time taken to arrive at a goal point, can be trained from the movement history data.

Moreover, the method of the present disclosure is applicable to an autonomous mobile robot as the agent. In such cases, a determination model, for determining an optimum timing to re-plan a low-cost path in an unknown environment in which an autonomous mobile robot has been placed by trial and error of the robot themself, can be autonomously acquired without needing to take the time of a designer to craft rules and for trial and error.

Moreover, a known method may be employed in a global planning unit and a local planning unit.

Note that although in the above exemplary embodiment an example has been described of a case in which the determination model is trained based on the movement history data of the agent 50 itself that is movement history data in the same movement environment, there is no limitation thereto. A configuration may be adopted in which a determination model is trained based on movement history data of the agent 50 itself that is movement history data in a different movement environment.

Moreover, a configuration may be adopted so as to train a determination model using movement history data obtained by movement of another agent. Moreover, a configuration may be adopted so as to train a determination model using movement history data obtained by simulation related to movement of an agent.

Moreover, although in the above exemplary embodiment examples have been described of cases in which path planning processing is executed in a control device separate to the agent, there is no limitation thereto. The path planning processing may be executed in a control device installed in the agent.

Moreover, although a case has been described in which an agent moving in a two-dimensional environment is envisaged, there is no limitation thereto. Application can be made to intersecting areas in a three-dimensional environment, such as drone flight paths.

Examples of specific applications of the present disclosure include an autonomous mobile robot in a factory, office, or distribution warehouse, and an autonomous serving robot in a restaurant. The pre-constructed obstacles are tables and partitions in the case of an autonomous serving robot in a restaurant. Moreover, newly appearing obstacles are people and moved seats that have been moved. In a restaurant, re-planning is performed at a high frequency in locations crowded with people due to there being many encounters with obstacles, and when there are wide paths the frequency of re-planning gets lower due to there being fewer situations of encounters with obstacles. As a result thereof, a low-cost path can be selected. Moreover, a configuration may be adopted in which time bands are segmented into time bands when there are many customers and time bands when there are few, and the frequency of re-planning can be varied therebetween.

Moreover, the path planning processing executed by the CPU reading in software (a program) in the above exemplary embodiment may be executed by various processors other than a CPU. Examples of such processors include programmable logic devices (PLD) that allow circuit configuration to be modified post-manufacture, such as a field-programmable gate array (FPGA), and dedicated electric circuits and the like, these being processors including a circuit configuration custom-designed to execute specific processing, such as an application specific integrated circuit (ASIC). The path planning processing may be executed by any one of these various types of processors, or may be executed by a combination of two or more of the same type or different type of processor (such as plural FPGAs, or a combination of a CPU and an FPGA). The hardware structure of these various types of processors is more specifically an electric circuit combining circuit elements such as semiconductor elements.

Moreover, although in the above exemplary embodiments an embodiment was described in which the path planning program was pre-stored (installed) on the storage device, there is no limitation thereto. The program may be provided in a format stored on a storage medium such as a CD-ROM, DVD-ROM, Blu-ray disc, USB memory, or the like.

Moreover, the program may be provided in a format downloadable from an external device over a network.

The following Supplements related to the present disclosure are disclosed.

### Supplement 1

A path planning device including:
a global planning unit that computes a low-cost path from a starting point to a goal point based on a pre-constructed map including positions of obstacles;
a local planning unit that specifies, for each time, a velocity or angular velocity of a moving body in order to follow the low-cost path;
a sensing unit that acquires sensor information measured for obstacles in a periphery of the moving body at each time;
a re-planning unit that re-computes the low-cost path based on the map and the sensor information;
a storage unit that stores a time series of the sensor information and a trajectory of the moving body; and
a timing determination unit that determines whether or not computing by the re-planning unit is to be performed using a pre-trained determination model for determining whether or not it is a timing for computation to be performed by the re-planning unit based on the time series of sensor information, the trajectory of the moving body, the low-cost path, and the goal point.

### Supplement 2

The path planning device of Supplement 1, further including a training unit that trains the determination model using reinforcement learning from movement history data from past starting points to goal points, which is movement history data including the sensor information at each time, the trajectory of the moving body, the low-cost path at each time, and the goal point.

### Supplement 3

The path planning device of Supplement 2, wherein a reward in the reinforcement learning is determined based on whether or not a goal point has been arrived at or an arrival time to the goal point.

### Supplement 4

The path planning device of Supplement 2 or Supplement 3, wherein the movement history data is obtained for a moving body that is the same as the moving body.

### Supplement 5

The path planning device of Supplement 2 or Supplement 3, wherein the movement history data is obtained for a moving body that is different from the moving body.

### Supplement 6

The path planning device of Supplement 2 or Supplement 3, wherein the movement history data is obtained by simulation related to movement of the moving body.

### Supplement 7

A path planning device including
memory, and
at least one processor connected to the memory, wherein
the processor is configured so as to:
   compute a low-cost path from a starting point to a goal point based on a pre-constructed map including positions of obstacles;
   specify for each time a velocity or angular velocity of a moving body in order to follow the low-cost path;
   acquire sensor information measured for obstacles in a periphery of the moving body at each time;
   re-compute the low-cost path based on the map and the sensor information;
   store a time series of the sensor information and a trajectory of the moving body; and
   determine, based on the time series of sensor information, the trajectory of the moving body, the low-cost path, and the goal point, whether or not to perform computing by the re-planning unit using a pre-trained determination model for determining whether or not it is a timing to perform computing of the low-cost path.

### Supplement 8

A non-transitory storage medium stored with an executable program such that path planning processing is executed by computer, the path planning processing being configured so as to:
compute a low-cost path from a starting point to a goal point based on a pre-constructed map including positions of obstacles;
specify for each time a velocity or angular velocity of a moving body in order to follow the low-cost path;
acquire sensor information measured for obstacles in a periphery of the moving body at each time;
re-compute the low-cost path based on the map and the sensor information;
store a time series of the sensor information and a trajectory of the moving body; and
determine, based on the time series of sensor information, the trajectory of the moving body, the low-cost path, and the goal point, whether or not to perform computing by the re-planning unit using a pre-trained determination model for determining whether or not it is a timing for performing computing of the low-cost path.

The entire content of the disclosure of Japanese Patent Application No. 2023-070470 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A path planning device comprising:
a memory; and
at least one processor coupled to the memory,
the at least one processor being configured to:
compute a low-cost path from a starting point to a goal point based on a pre-constructed map including positions of obstacles;
specify, for each time, a velocity or angular velocity of a moving body in order to follow the low-cost path;
acquire sensor information measured for obstacles in a periphery of the moving body at each time;
re-compute the low-cost path based on the map and the sensor information;
store a time series of the sensor information and a trajectory of the moving body; and
determine whether or not re-computing is to be performed using a pre-trained determination model for determining whether or not it is a timing for re-computing to be performed based on the time series of the sensor information, the trajectory of the moving body, the low-cost path, and the goal point.

2. The path planning device of claim 1, wherein:
the at least one processor is further configured to train the determination model using reinforcement learning from movement history data from past starting points to goal points, which is movement history data including the sensor information at each time, the trajectory of the moving body, the low-cost path at each time, and the goal point.

3. The path planning device of claim 2, wherein a reward in the reinforcement learning is determined based on whether or not a goal point has been arrived at or an arrival time to the goal point.

4. The path planning device of claim 2, wherein the movement history data is obtained for a moving body that is the same as the moving body.

5. The path planning device of claim 2, wherein the movement history data is obtained for a moving body that is different from the moving body.

6. The path planning device of claim 2, wherein the movement history data is obtained by simulation related to movement of the moving body.

7. A path planning method for execution by a computer, the method comprising:
computing a low-cost path from a starting point to a goal point based on a pre-constructed map including positions of obstacles;
specifying, for each time, a velocity or angular velocity of a moving body in order to follow the low-cost path;
acquiring sensor information measured for obstacles in a periphery of the moving body at each time;
storing a time series of the sensor information and a trajectory of the moving body in a storage unit;
determining, based on the time series of the sensor information, the trajectory of the moving body, the low-cost path, and the goal point, whether or not to re-compute the low-cost path by using a pre-trained determination model for determining whether or not it is a timing for re-computing the low-cost path; and
re-computing the low-cost path based on the map and the sensor information in a case in which determination was to re-compute the low-cost path.

8. (canceled)

9. A movement control system including a control device and a moving body, wherein:
the control device comprises:
a global planning unit that computes a low-cost path from a starting point to a goal point based on a pre-constructed map including positions of obstacles,
a local planning unit that specifies, for each time, a velocity or angular velocity of the moving body in order to follow the low-cost path,
a sensing unit that acquires sensor information measured for obstacles in a periphery of the moving body at each time,
a re-planning unit that re-computes the low-cost path based on the map and the sensor information,
a storage unit that stores a time series of the sensor information and a trajectory of the moving body,
a timing determination unit that determines whether or not computing by the re-planning unit is to be performed using a pre-trained determination model for determining whether or not it is a timing for computation to be performed by the re-planning unit based on the time series of the sensor information, the trajectory of the moving body, the low-cost path, and the goal point, and
a communication unit that notifies the moving body of the velocity or angular velocity of the moving body specified for each time; and
the moving body:
notifies the control device of sensor information measured for obstacles in the periphery of the moving body at each time, and
moves according to the notified velocity or angular velocity of the moving body.
